(19) United States
(12) Patent Application Publication
(10) Pub. No.: US 2009/0174100 A1
(43) Pub. Date: Jul. 9, 2009

(54) METHODS OF ENCAPSULATING A SUBSTANCE

(76) Inventors: James Rolfe, Gloucestershire (GB); Warrick Allen, Worcester (GB)

Correspondence Address: KING & SCHICKLI, PLLC, 247 NORTH BROADWAY, LEXINGTON, KY, 40507, US

(21) Appl. No.: 12/271,961

(22) Filed: Nov. 17, 2008

(30) Foreign Application Priority Data
Nov. 17, 2007 (GB) 0722631.9

(51) Int. Cl. B29C 39/10; B01J 13/02

(52) U.S. Cl. 264/4; 427/213.3

(57) ABSTRACT

Methods of encapsulating a substance including mixing a monomer with the substance to form a desired shape, and polymerizing the monomer.

### FIELD OF THE INVENTION

This invention relates to methods of encapsulating a substance.

### BACKGROUND OF THE INVENTION

Microencapsulation is a well known process by which small amounts of a gas, liquid or solid are encapsulated within a shell material in order to shield the encapsulated substance. The contents of the capsule can be released at a later time by various means that are well known in the art, such as mechanical rupture of the capsule wall, or melting of the capsule wall. Typically, the individual capsules are of small dimensions, and contain only a small amount of the substance. It is also typical that the microencapsulation process involves the mixing of immiscible liquid phases, i.e. a polar phase and a non-polar phase, in order for microencapsulation to be brought about. Most activity has been directed towards encapsulation of non-polar materials, although the Applicant's earlier International patent application WO 2007/012860 describes a system which can readily permit encapsulation of polar substances, in particular water.

### SUMMARY OF THE INVENTION

The present inventors have realised that there is a need for a technique which can provide larger capsules which encapsulate larger amounts of a desired substance. Furthermore, the present inventors have realised that it would be desirable to be able to readily produce the capsules in a desired size and/or shape. This is not readily possible, if at all, with conventional microencapsulation techniques, in which the size of the micro capsules produced is essentially determined by the physico-chemical nature of the micro-encapsulation system utilised. Furthermore, the present inventors have realised that it would be desirable and convenient to be able to perform encapsulation without requiring the presence of a two-phase polar/non-polar system.

The present invention, in at least some of its embodiments, addresses the above described problems and desires.

According to the invention there is provided a method of encapsulating a substance including the steps of:

providing a monomer which includes a group of sub-formula (I)

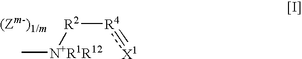

where R² and R³ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, and

R⁴ and R⁵ are independently selected from CH or CR¹¹ where R¹¹ is an electron withdrawing group;

the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen, fluorine or other substituents;

R¹ is selected from hydrogen, halo, nitro, or hydrocarbyl, optionally substituted or interposed with functional groups;

R¹² is selected from hydrogen, halo, nitro, hydrocarbyl, optionally substituted or interposed with functional groups, or

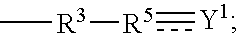

and

Z is an anion of charge m;

mixing the monomer with the substance and, optionally, at least one of a solvent for the monomer and an initiator to form a monomer containing mixture;

placing a pre-determined quantity of the monomer containing mixture in a pre-determined location so as to form a desired shape; and

polymerising the monomer so as to produce a polymeric matrix of a desired shape which encapsulates the substance.

In this way bulk polymeric matrices containing a substance of interest of essentially predetermined size and/or shape can be produced. It is not necessary to utilise a two-phase polar/non-polar liquid system in order to perform the encapsulation, and in preferred embodiments of the invention a one-phase system is utilised.

International publications WO 00/06610, WO 00/06533, WO 00/06658, WO 01/40874, WO 01/74919 and WO 2007/012860, the contents all of which are herein incorporated by reference, disclose polymers of the dienyl type, corresponding monomers, and methods for preparing the polymers and monomers. International publication WO 01/74919 also discloses polymers formed from quaternary ammonium species having a single vinyl type group. However, these publications do not even suggest that encapsulation of the type described herein might be contemplated.

A solvent for the monomer, when used, acts to dissolve the monomer, and is particularly useful when the monomer is not a liquid and the substance to be encapsulated is not capable of dissolving the monomer.

Advantageously, the pre-determined quantity of the monomer containing mixture is placed in a mould of a desired shape. Subsequent polymerisation of the monomer produces a polymeric matrix of a shape essentially corresponding to that of the mould.

In other preferred embodiments, one or more pre-determined quantities of the monomer containing mixture are deposited in a controlled and repeatable manner on one or more surfaces having controlled characteristics so that the quantities of the monomer containing mixtures form desired shapes, and the monomer in each deposited mixture is polymerised to produce at least one polymeric matrix of a desired shape, each of which encapsulates the substance.

A pre-determined quantity of the monomer containing mixture may be deposited and optionally spread over a surface so as to enable the production of a film of the polymeric matrix. Alternatively, a plurality of pre-determined quantities of the monomer contained mixture may be deposited separately at discrete locations on a surface, enabling the production of a plurality of polymeric matrices of a desired shape. The surface or surfaces may comprise a glass substrate optionally with a surface treatment such as a silane treatment.

The polymeric matrix may be subjected to a heat treatment.

The polymeric matrix may be a capsule of dimensions greater than 1 mm. This is understood to refer to a ‘three dimensional’ matrix having dimensions along three orthogonal axes which are greater than 1 mm. Capsules of dimensions in the range 1-3 mm can be readily produced, although capsules of larger dimensions, for example 5 mm or greater, may be produced. It is also possible to produce capsules of dimensions less than 1 mm.

In some preferred embodiments, the substance is a liquid. Advantageously, the liquid may act as a solvent for the monomer, and the mixing of the monomer with the liquid causes the liquid to dissolve the monomer.

It is understood that in embodiments in which the substance is a liquid, the substance may be a pure liquid, or the liquid may include one or more solutes dissolved in a solvent. In the latter instance, the substance may be an acid, such as nitric acid, phosphoric acid or citric acid. In embodiments in which the substance is an acid, it is preferred that R¹ and R¹² are not hydrogen so that the monomer and polymer are substantially neutral.

Advantageously, the substance includes a polar liquid.

Additionally or alternatively, the monomer and the substance may be additionally mixed with a solvent for the monomer, wherein the solvent for the monomer is a polar liquid.

Preferably, the polar liquid is water, although other polar liquids, such as dimethyl sulphoxide (DMSO) might be used.

In other preferred embodiments, the substance is a solid. The substance may be an ionic solid, such as sodium dithionate. In embodiments in which the substances are solid, it can be particularly useful to utilise at least one solvent for the monomer when mixing the monomer with the substance to form a monomer containing mixture, particularly when the monomer is a solid as well.

The invention can be used to encapsulate a wide range of substances. An advantage of the invention is that it can be used to encapsulate hazardous substances, allowing a hazardous substance to be transported in a safe manner. Thus, a substance may be a hazardous chemical, such as a biocide, an oxidising agent, a reducing agent, an acid, or an alkali.

In preferred embodiments the substance can be released from the polymeric matrix by at least partially dissolving the polymer. The polymer may be dissolved by contact with a polar liquid, and preferably the polar liquid is water. It is advantageous that it is readily possible to produce polymers from monomers which include a group of sub-formula (I) which can be dissolved by water.

Preferably, the monomer is polymerised by exposure to ultraviolet radiation. Alternative polymerisation methods include the application of heat (which may be in the form of IR radiation), where necessary in the presence of an initiator, by the application of other sorts of initiator such as chemical initiators, or by initiation using an electron beam. The expression “chemical initiator” as used herein refers to compounds which can initiate polymerisation such as free radical initiators and ion initiators such as cationic or anionic initiators as are understood in the art. In the preferred embodiments in which the monomer is polymerised by exposure to ultraviolet radiation, polymerisation may take place either spontaneously or in the presence of a suitable initiator. Examples of suitable initiators include 2,2′-azobisisobutyronitrile (AIBN), aromatic ketones such as benzophenones in particular acetophenone; chlorinated acetophenones such as di- or tri-chloracetophenone; dialkoxyacetophenones such as dimethoxyacetophenones (sold under the trade name “Irgacure 651”) dialkylhydroxyacetophenones such as dimethylhydroxyacetophenone (sold under the trade name “Darocure 1173”); substituted dialkylhydroxyacetophenone alkyl ethers such compounds of formula

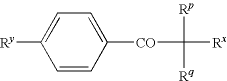

where R^{y} is alkyl and in particular 2,2-dimethylethyl, R^{x} is hydroxyl or halogen such as chloro, and R^{p} and R^{q} are independently selected from alkyl or halogen such as chloro (examples of which are sold under the trade names “Darocure 1116” and “Trigonal P1”); 1-benzoylcyclohexanol-2 (sold under the trade name “Irgacure 184”); benzoin or derivatives such as benzoin acetate, benzoin alkyl ethers in particular benzoin butyl ether, dialkoxybenzoins such as dimethoxybenzoin or deoxybenzoin; dibenzyl ketone; acyloxime esters such as methyl or ethyl esters of acyloxime (sold under the trade name “Quantaqure PDO”); acylphosphine oxides, acylphosphonates such as dialkylacylphosphonate, ketosulphides for example of formula

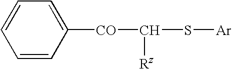

where R^{z} is alkyl and Ar is an aryl group; dibenzoyl disulphides such as 4,4′-dialkylbenzoyidisulphide; diphenyldithiocarbonate; benzophenone; 4,4′-bis (N,N-dialkyamino) benzophenone; fluorenone; thioxanthone; benzil; or a compound of formula

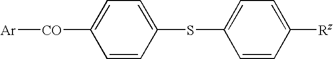

where Ar is an aryl group such as phenyl and R^{z} is alkyl such as methyl (sold under the trade name “Speedcure BMDS”).

As used herein, the term “alkyl” refers to straight or branched chain alkyl groups, suitably containing up to 20 and preferably up to 6 carbon atoms. The terms “alkenyl” and “alkynyl” refer to unsaturated straight or branched chains which include for example from 2-20 carbon atoms, for example from 2 to 6 carbon atoms. Chains may include one or more double to triple bonds respectively. In addition, the term “aryl” refers to aromatic groups such as phenyl or naphthyl.

The term “hydrocarbyl” refers to any structure comprising carbon and hydrogen atoms. For example, these may be alkyl, alkenyl, alkynyl, aryl such as phenyl or napthyl, arylalkyl, cycloalkyl, cycloalkenyl or cycloalkynyl. Suitably they will contain up to 20 and preferably up to 10 carbon atoms. The term “heterocylyl” includes aromatic or non-aromatic rings, for example containing from 4 to 20, suitably from 5 to 10 ring atoms, at least one of which is a heteroatom such as oxygen, sulphur or nitrogen. Examples of such groups include furyl, thienyl, pyrrolyl, pyrrolidinyl, imidazolyl, triazolyl, thiazolyl, tetrazolyl, oxazolyl, isoxazolyl, pyrazolyl, pyridyl, pyrimidinyl, pyrazinyl, pyridazinyl, triazinyl, quinolinyl, isoquinolinyl, quinoxalinyl, benzthiazolyl, benzoxazolyl, benzothienyl or benzofuryl.

The term “functional group” refers to reactive groups such as halo, cyano, nitro, oxo, C(O)ₙR^{a}, OR^{a}, S(O)ₜR^{a}, NR^{b}R^{c}, OC(O)NR^{b}R^{c}, C(O)NR^{b}R^{c}, OC(O) NR^{b}R^{c}, —NR⁷C(O)ₙR⁶, —NR^{a}CONR^{b}R^{c}, —C═NOR^{a}, —N═CR^{b}R^{c}, S(O)ₜNR^{b}R^{c}, C(S)ₙR^{a}, C(S)OR^{a}, C(S)NR^{b}R^{c} or —NR^{b}S(O)ₜR^{a} where R^{a}, R^{b} and R^{c} are independently selected from hydrogen or optionally substituted hydrocarbyl, or R^{b} and R^{c} together form an optionally substituted ring which optionally contains further heteroatoms such as S(O)ₛ, oxygen and nitrogen, n is an integer of 1 or 2, t is 0 or an integer of 1-3. In particular, the functional groups are groups such as halo, cyano, nitro, oxo, C(O)ₙR^{a}, OR^{a}, S(O)ₜR^{a}, NR^{b}R^{c}, OC(O)NR^{b}R^{c}, C(O)NR^{b}R^{c}, OC(O)NR^{b}R^{c}, —NR⁷C(O)ₙR⁶, —NR^{a}CONR^{b}R^{c}, —NR^{a}CSNR^{b}R^{c}, C═NOR^{a}, —N═CR^{b}R^{c}, S(O)ₜNR^{b}R^{c}, or —NR^{b}S(O)ₜR^{a} where R^{a}, R^{b} and R^{c}, n and t are as defined above.

The term “heteroatom” as used herein refers to non-carbon atoms such as oxygen, nitrogen or sulphur atoms. Where the nitrogen atoms are present, they will generally be present as part of an amino residue so that they will be substituted for example by hydrogen or alkyl.

The term “amide” is generally understood to refer to a group of formula C(O)NR^{a}R^{b} where R^{a} and R^{b} are hydrogen or an optionally substituted hydrocarbyl group. Similarly, the term “sulphonamide” will refer to a group of formula S(O)₂NR^{a}R^{b}. Suitable groups R^{a} include hydrogen or methyl, in particular hydrogen.

The nature of any electron withdrawing group or groups additional to the amine moiety used in any particular case will depend upon its position in relation to the double bond it is required to activate, as well as the nature of any other functional groups within the compound. The term “electron withdrawing group” includes within its scope atomic substituents such as halo, e.g. fluro, chloro and bromo, and also molecular substituents such as nitrile, trifluoromethyl, acyl such as acetyl, nitro, or carbonyl.

Where R¹¹ is an electron withdrawing group, it is suitably acyl such as acetyl, nitrile or nitro.

Preferably, R⁷ and R⁸ are independently selected from fluoro, chloro or alkyl or H. In the case of alkyl, methyl is most preferred.

Preferably, X², X³, Y² and Y³ are all hydrogen.

Alternatively, it is possible that at least one, and possibly all, of X², X³, Y² and Y³ is a substituent other than hydrogen or fluorine, in which instance it is preferred that at least one, and possibly all, of X², X³, Y² and Y³ is an optionally substituted hydrocarbyl group. In such embodiments, it is preferred that at least one, and most preferably all, of X², X³, Y² and Y³ is an optionally substituted alkyl group. Particularly preferred examples are C₁ to C₄ alkyl groups, especially methyl or ethyl. Alternatively, at least one, and preferably all, of X², X³, Y² and Y³ are aryl and/or heterocyclic such as pyridyl, pyrimidinyl, or a pyridine or pyrimidine containing group.

In preferred embodiments, X¹ and Y¹ are groups CX²X³ and CY¹Y² respectively and the dotted lines represent an absence of a bond. Thus preferred compounds are those of sub-formula (IA)

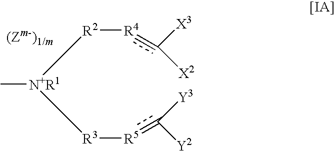

where R¹, R², R³, R⁴, R⁵, R⁶, X², X³, Y² and Y³ are as defined above.

When the dotted bonds in sub formula (I) are present, the resulting polymer will comprise polyacetylene chains. This can lead to a conjugated system, and consequently a conducting polymer.

Preferred anions Z^{m-} are halide ions, preferably Br⁻, tosylate, triflate, a borate ion, PF₆⁻, or a carboxylic acid ester anion.

A preferred group of the compounds for use in the method of the invention is a compound of structure (II)

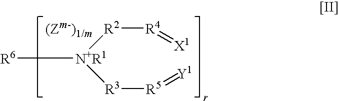

and in particular a compound of formula (IIA)

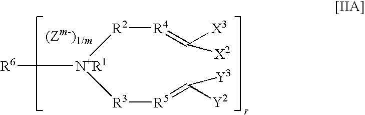

where X¹, X², X³, Y¹, Y², Y³, R², R³, R⁴, R⁵ and the dotted bonds are as defined in relation to formula (I) above, r is an integer of 1 or more, and R⁶ is a bridging group, an optionally substituted hydrocarbyl group, a perhaloalkyl group, a siloxane group or an amide.

Where in the compound of formula (II) and (IIA), r is 1, compounds can be readily polymerised to form a variety of polymer types depending upon the nature of the group R⁶. Embodiments in which r is 1 or 2 are most preferred. Monomers in which r is 1 may be represented as structure (III)

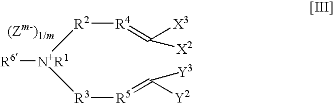

where X², X³, Y², Y³, R², R³, R⁴, and R⁵ are as defined in relation to formula (I) above, R⁶′ is an optionally substituted hydrocarbyl group, a perhaloalkyl group, a siloxane group or an amide.

Where in the compounds of formula (II), r is greater than one, polymerisation can result in polymer networks. Particular examples are compounds of formula (II) as defined above, where R⁶ is a bridging group and r is an integer of 2 or more, for example from 2 to 8 and preferably from 2-4.

On polymerisation of these compounds, networks are formed whose properties maybe selected depending upon the precise nature of the R⁶ group, the amount of chain terminator present and the polymerisation conditions employed. Examples of bridging groups can be found in WO 00/06610.

R⁶ or R⁶′ may be an optionally substituted hydrocarbyl group having three or more carbon atoms.

R⁶ or R⁶′ may be a straight or branched chain alkyl group, optionally substituted or interposed with functional groups. R⁶ or R⁶′ may have between one and twenty carbon atoms, preferably between two and twelve carbon atoms. For the avoidance of doubt, the term ‘between x and y carbon atoms’ as used herein refers to the range x to y carbon atoms and includes embodiments having x carbon atoms and embodiments having y carbon atoms.

In preferred embodiments, R¹ and R⁶ or R⁶′ together with the quaternarised N atom to which they are attached form a heterocyclic structure. Preferably, R¹ and R⁶ or R⁶′ together with the quaternerised N to which they are attached form an optionally substituted heterocyclic structure comprising a four to eight membered ring. The optionally substituted heterocyclic structure may be a five or a six membered ring. Most preferably, R⁶ or R⁶′ together with the quaternarised N to which they are attached form an optionally substituted piperidine ring. Polymeric matrices formed from these monomers are particularly useful for encapsulating acids, because they can be stable over time. A further advantage is that these monomers and polymers tend to be neutral owing to the absence of H⁺ moieties on the quaternarised nitrogens. U.S. Pat. No. 3,912,693, the contents of which are herein incorporated by reference, discloses processes for producing and polymerising monomers of the type in which R¹ and R⁶ or R⁶′ together with the quaternarised N atom to which they are attached form a heterocyclic structure. However, this publication does not even suggest that encapsulation of the type described herein might be contemplated.

The monomer may be a compound of formula (IV)

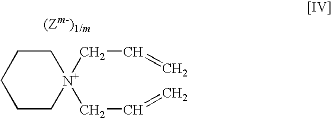

The heterocyclic structure may include at least one additional heteroatom in addition to the quaternarised N to which R¹ and R⁶ or R⁶′ are attached. The additional heteroatom may be N, O or S. Preferably, the heterocyclic structure includes at least two N heteroatoms, in which instance the monomer may be a compound of formula (V)

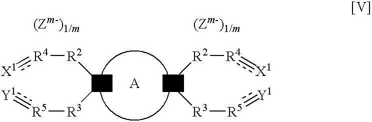

where A is a four to eight membered heterocyclic ring and the quaternarised nitrogens are present at any suitable pair of positions in the ring. Preferably, A is a five or six membered heterocyclic ring. In embodiments in which A is a six membered heterocyclic ring, the ring may be a 1,2, a 1,3, or a 1,4 N substituted ring.

Advantageously, A is an optionally substituted piperazine ring. The monomer may be a compound of formula (VI)

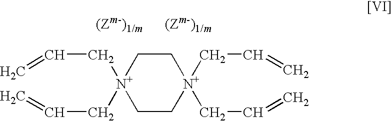

In other preferred embodiments, the monomer is a compound of formula (VII)

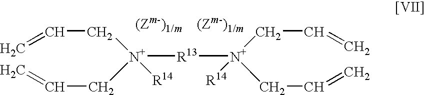

where R¹³ is a straight or branched alkyl group, preferably having between one and twenty carbon atoms, most preferably having between two and twelve carbon atoms; and

R¹⁴ is hydrogen or a straight or branched alkyl group, preferably having between one and five carbon atoms, most preferably methyl or ethyl.

In a preferred embodiment, the monomer is a compound of formula (VIII)

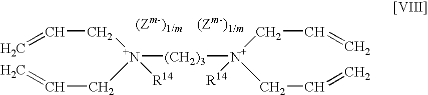

In another preferred embodiment, the monomer is a compound of formula (IX)

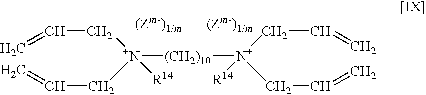

In the compounds of formulae (VIII) and (IX), it is preferred that R¹⁴ is methyl.

Most preferably, Z^{m-} is Br⁻. This anion is particularly useful when acids such as nitric acid are encapsulated, since it can confer stability on the resulting polymer. Tosylate and triflate anions are also stable in acidic media and thus represent further preferred embodiments of Z^{m-} when acids are encapsulated.

R¹ may be H, an alkyl group, preferably having less than 3 carbon atoms, most preferably methyl, or

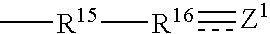

where R¹⁵ and R¹⁶ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, the dotted lines indicate the presence or absence of a bond, and Z¹ is a group CZ²Z³ where the dotted line bond to which it is attached is absent and a group CZ² where the dotted line bond to which it is attached is present, and Z²,Z³ are independently selected from hydrogen, fluorine or other substituents.

In embodiments in which R¹² is not

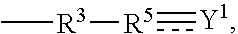

the monomer is preferably of the following formula

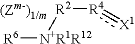

where R⁶ is as previously defined and may be a group R⁶′ as previously defined.

The step of polymerising the monomer may produce a homopolymer.

Alternatively, the step of polymerising the monomer may produce a copolymer, the monomer being mixed with different monomeric units. The co-monomer having different monomeric units may include a group of sub-formula (I). The co-monomer may be according to any of the formulae described above. Alternatively, the co-monomer may be of a different class of compounds. The monomer may be copolymerised with a cross-linker. The cross-linker may be a compound of formula (VII) as described above and preferably is a compound of formula (VIII) or (IX) as defined above.

Preferably, the substance encapsulated within a polymeric matrix formed from a copolymer is released by at least partially dissolving the copolymer. The copolymer can be wholly dissolved, or portions of the polymeric matrix may be dissolved to release the substance. In the latter instance, it is envisaged that the polymeric matrix may retain enough structural integrity so that it can be removed from the point of release after sufficient time has elapsed so that a desired quantity of the substance has been released. The extent to which the polymeric matrix dissolves during release of the substance can be varied for example by varying the concentration of cross-linker utilised in the preparation of the monomer containing mixture.

At least some monomers in which R¹ and R⁶ or R⁶′ together with the quaternarised N atom to which they are attached form a heterocyclic structure are believed to be novel per se, as are polymers formed therefrom. Accordingly, in further aspects of the invention there are provided compounds of the type described above in which R¹ and R⁶ or R⁶′ together with the quaternarised N atom to which they are attached form a heterocyclic structure, and polymers formed therefrom. Yet further aspects of the invention provide methods of making said compounds and methods of polymerising said polymers. The methods utilised can be as generally described herein, although the skilled reader will appreciate that in these aspects of the invention the polymerisation is not necessarily in connection with a method of encapsulating a substance. Rather, the polymerisation can refer to a general polymerisation step, e.g. one in which a polymer is produced without the presence of a substance which is encapsulated within the polymer. Further details concerning polymerisation methods which an be applied to compounds of the type in which R¹ and R⁶ or R⁶′ together with the quaternarised N atom to which they are attached form a heterocyclic structure can be found in International publications WO 00/06610, WO 00/06533 and WO 00/06658.

Whilst the invention has been described above, it extends to any inventive combination or sub-combination of the features set out above or in the following description, drawings or claims.

### BRIEF DESCRIPTION OF THE DRAWING FIGURES

Embodiments of methods in accordance with the invention will now be described with reference to the accompanying drawings, in which:

FIG. 1 is a schematic diagram illustrating (a) a first method, (b) a second method and (c) a third method of the invention;

FIG. 2 shows pH change after addition of sodium dithionite containing film; and

FIG. 3 shows pH change after addition of nitric acid containing pellets.

### DETAILED DESCRIPTION OF THE INVENTION

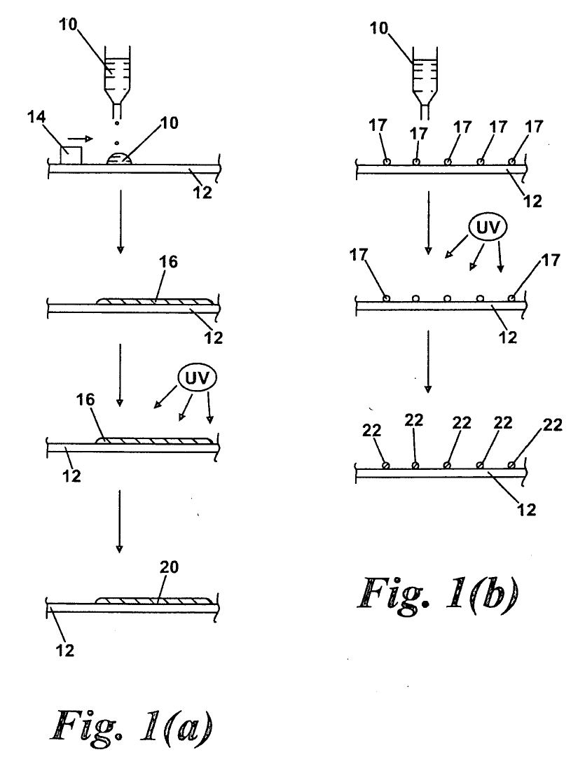

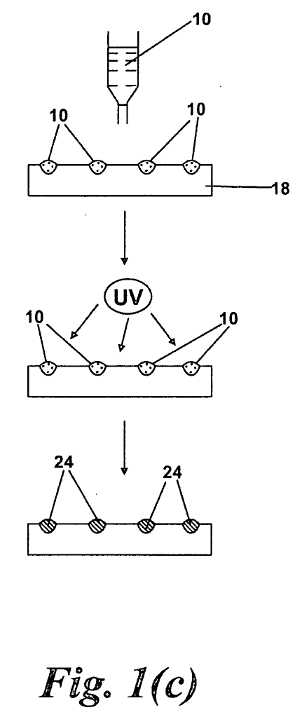

FIG. 1 shows three embodiments of methods of the present invention. In all three cases, a monomer containing mixture 10 is prepared using techniques which are further explained herein. In the first embodiment shown in FIG. 1(a), a known quantity of the monomer containing mixture 10 is deposited on a surface 12 and spread with a spreader 14 to form a thin film 16. In the second embodiment shown in FIG. 1(b), predetermined quantities of the monomer containing mixture 10 are deposited on to the surface 12 to form discrete droplets 17 which remain in place, i.e. no spreading is performed. In the third embodiment shown in FIG. 1(c), monomer containing mixture 10 is introduced into a mould 18. In all cases, the monomer containing mixture, once present in its final deposited state, is exposed to UV radiation which causes the monomer to polymerise. In the case of the first embodiment, this UV treatment results in the production of a polymeric film 20 encapsulating the substance. In the second and third embodiments, the UV polymerisation results in the production of discrete capsules 22,24, respectively.

### EXAMPLE 1

### Synthesis of N,N-diallylammonium piperidine bromide (1)

The target molecule 1 is shown below:

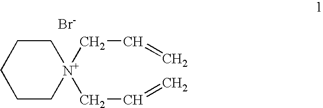

Diallylamine (99%, Aldrich, 65 g) was added to a mixture of 1,5-dibromopetane (97%, Aldrich, 150 g), potassium carbonate (99%, 180 g) and ethyl alcohol (99+%, 100 ml) into a 3 necked, 1 litre reaction flask with temperature monitoring and reflux. After heating towards reflux the reaction proceeded far more quickly from 70° C. onwards. The reaction was maintained at reflux for 1 hour and then cooled to room temperature and left for 18 hours.

Dichloromethane (GPR, 100 ml) was added, the potassium carbonate was filtered off and the liquor was then mixed into water (300 ml). Xylenes (100 ml) were then added and thoroughly mixed with the aqueous solution containing the product to remove a yellow oily impurity from the product. This was repeated with n-hexane, followed by removal of water under vacuum to afford an off-white solid product (yield ca. 70%).

### EXAMPLE 2

### Release of Sodium dithionite (Na₂S₂O₄) into water from a thin film of N,N-diallyl piperidine bromide quaternary polymer

The monomer formulation was made by dissolving monomer 1 (2.0 g) into water (0.50 g from tap, pH˜7.6) followed by addition of Ciba Irgacure 184 photoinitiator (2% w/w CPQ) with thorough dissolving and mixing. Finely powered sodium dithionite (0.60 g) was then added and mixed thoroughly into the solution.

A thin film (approximately 1 mm thickness) was then made by the spreading the monomer formulation with a hand K-bar spreader onto a glass substrate. This was cured under a focused Fe doped Hg lamp (FusionUV F300S, 120 W/cm) at 2 m/min with 3 passes.

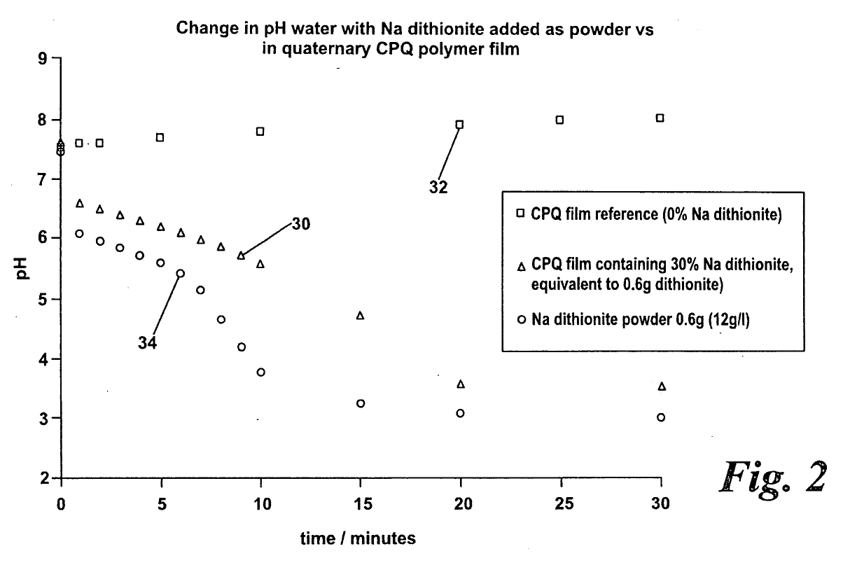

The whole of the resulting pale yellow film was removed from the glass and placed into a small beaker containing 50 ml of tap water at 20° C. with constant stirring. The pH was then monitored over time as the film dissolved into the water. A control experiment of sodium dithionite powder (0.60 g) placed into the water using the same conditions as above was performed and the pH monitored over time. A further control experiment was performed in which a thin film was prepared as described above but using a formulation which did not contain sodium dithionite. The results of these experiments are shown in FIG. 2, wherein the data points 30 show pH values obtained with the polymer/sodium dithionite film, data points 32 show pH values obtained with the polymer film having no sodium dithionite present, and the data points 34 show pH values obtained with sodium dithionite powder in water.

Both the film containing sodium dithionite and the dithionite control appeared to fully dissolve in the water over 30 minutes. The polymer film appears to provide a somewhat phased release of sodium dithionite, and it is likely that the release characteristics can be carried by altering the proportions of monomer and sodium dithionite utilised.

### EXAMPLE 3

### Release of nitric acid into water from pellets of N,N-diallyl piperidine bromide quaternary polymer

A monomer formulation was made by dissolving monomer 1 (2.5 g) into dilute nitric acid (0.87 g of 35 wt % in water) followed by addition of Ciba Irgacure 2022 photoinitiator (3% w/w with respect to the monomer) with thorough dissolving and mixing.

The solution was then transferred to a needle syringe and deposited as small droplets, 2 to 3 mm in diameter, onto a ‘non-stick’ silane (Repelcote (VS), BDH) treated glass plate. The droplets were cured using a Ga doped Hg bulb (120 W/cm, Fusion UV300S) by passing the plate twice under the lamp at 1.5 m/min for the top and twice for underside of the glass.

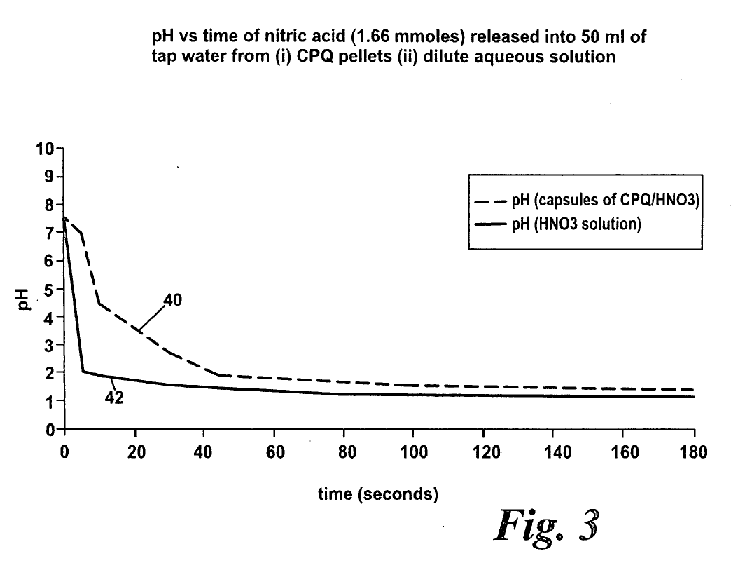

Solid pellets were formed, which were then dried further by placing in an oven for 60 minutes at 70° C. This drying step removed ˜20% by weight of the water in the pellets. The dried pellets were then removed from the glass by gently scraping off the glass surface. A portion of these (0.714 g) were placed into a smaller beaker containing 50 ml of tap water at 20° C. with constant stirring with the pH monitored over time using a pH meter. As a control experiment, the same amount of nitric acid that was added to the pellets was monitored for pH vs time under the same conditions. The results of these experiments are shown in FIG. 3, wherein the data points 40 show pH values obtained with the polymer/nitric acid pellets, and data points 42 show pH valves obtained with nitric acid alone. The pellets appear to release the nitric acid pay load quickly, with a pH value of 2 being attained by ca. 45 seconds. The pellets appear to provide a somewhat phased release in comparison to the direct addition of nitric acid, and it is likely that the release characteristics can be varied by altering the proportions of monomer and nitric acid utilised.

### EXAMPLE 4

### Synthesis of N,N,N′,N′-Tetraallyldecane-1,10-dimethylammonium triflate(2)

The target molecule is shown below

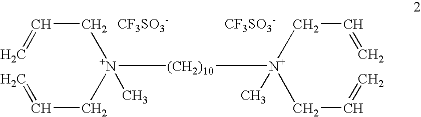

Diallylamine (99%, 70 g, 0.72 moles), 1,10-dibromodecane (97%, 100 g, 0.33 moles) and potassium carbonate (99%+dry, 200 g, 0.69 moles) were charged into a reaction vessel containing ethanol (100 ml) and refluxed for 96 hours. After cooling the reaction mixture, dichloromethane (50 ml) was added and the mixture was then filtered to remove the potassium carbonate and other salts. Solvent and excess diallylamine were removed by rotary evaporation to produce yellow oil, which was purified by column chromatography using silica (60 Å) and dichloromethane as eluent. Dichloromethane was removed under vacuum to produce the N,N,N′,N′-tetraallyldecane-1,10-diamine intermediate as a pale yellow oil. Yield˜75%.

N,N,N′,N′-tetraallyldecane 1,10 diamine intermediate (33.26 g, 100 mmoles) was added to dichloromethane (dried, 230 g, 2.7 moles) and charged into a reaction flask and was heated to reflux. Methyl trifluoromethane sulphonate (>98%, 37.09 g, 226 mmoles) was then added dropwise over 60 minutes with reflux maintained for another 3 hours. After removal of dichloromethane under vacuum N,N,N′,N′-tetraallyldecane-1,10-dimethyl ammonium trifluoromethane sulphonate product was then obtained as an off-white solid.

### EXAMPLE 5

### Release of nitric acid into water from pellets of N,N-diallyl piperidine bromide/N,N,N′,N′-Tetraallyldecane-1,10-dimethylammonium triflate copolymer

N,N-diallylpiperidine bromide (1.50 g) and N,N,N′,N′-tetraallyldecane-1,10-dimethylammonium triflate (0.50 g) were added to nitric acid (35wt %, 0.70 g) and mixed thoroughly with gentle heating to 40° C. to produce a viscous solution. After the solution had cooled Irgacure 2022 (3% w/w monomer) was added and stirred thoroughly into the solution for several minutes.

The solution was transferred to a syringe and added as drops onto a hydrophobic silicone treated glass plate (Repelcote (VS) BDH); each drop ranged from approximately 1 mm to 3 mm in diameter. The plate was then passed twice under a UV lamp (FusionUVF300S, Ga doped bulb, 120 W/cm, 1.5 m/min) and then placed into an oven at 90° C. for 1 hour, which partially dried the pellets to a rubbery solid.

0.1 g of the pellets produced were added to tap water (pH˜7.6, 10 ml, 20° C.) with occasional stirring. The pH decreased gradually to a pH of 3.6 after four minutes and pH 3.2 after 10 minutes indicating that the acidic payload had been released from the pellets. Little or no change in the size or appearance of the pellets was observed. The acidic solution created by the pellets was filtered off and produced 0.022 g of evaporation residue produced after removal of all water, suggesting over 90% of the polymer remained insoluble in water after releasing the acidic payload and traces of initiator.

### EXAMPLE 6

### Synthesis of N,N,N′,N′-Tetraallylpropane-1,3-dimethylammonium tosylate(3)

The target molecule 3 is shown below

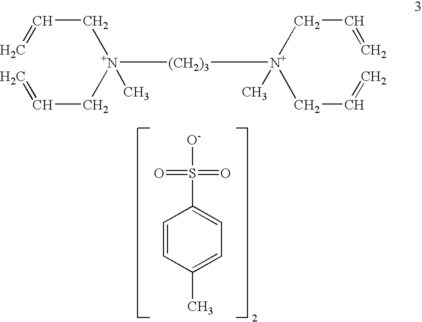

### A. Synthesis of Diamine Intermediate:

1,3-dibromopropane (99%, 150.0 g, 0.743 moles), diallylamine (99%, 160.5 g, 1.652 moles), potassium carbonate (97%, 456 g, 3.300 moles) and 2-propanol (400 ml) were added to a 5-necked rb reaction flask and brought to reflux with stirring. This was maintained for 120 hours then cooled. The mixture was then filtered and the volatiles removed under vacuum. A yellow oil was produced, which was further purified by column chromatography using silica (60 Å) and DCM as eluent. After removal of the DCM a pale yellow oil was produced (density=0.86 g/cm³, yield=80%).

B. Synthesis of Quaternary Ammonium Salt from Tertiary Diamine

Methyl-para-toluene sulfonate (98%, 216 g, 1.1598 moles) was added dropwise over 120 minutes to a refluxing mixture of the diamine intermediate (120 g, 0.5128 moles) and tetrahydrofuran (600 ml).

After a further 120 minutes refluxing, the reaction mixture was allowed to cool and the product precipitated as a soft white, hygroscopic solid. The supernatant liquid (containing THF and any unreacted starting materials) was removed and then approximately 1500 ml of acetone was added to the flask. The mixture was then stirred for 15 minutes and the white precipitate was filtered under vacuum (yield approx. 87%). This product was then washed in fresh, cold acetone and dried at ˜40° C. to yield a white powder (final yield approx. 65%).

### EXAMPLE 7

### Release of nitric acid into water from pellets of N,N-diallyl piperidine bromide/N,N,N′,N′-Tetraallylpropane-1,3-dimethylammonium tosylate copolymer

The same method as for Example 5 was used but using following materials N, N,N′,N′ tetrallylpropane-1,3-dimethylammonium tosylate (0.50 g), N,N-diallylpiperidine bromide

(1.50 g) with Nitric acid (35 wt %, 0.70 g) and Irgacure 2022 (3% w/w monomer).

Acid solution was released gradually with a large change in pH over the first few minutes and more gradually after with a similar trend to that seen in Example 5.

The polymer was mostly insoluble in water with <10% soluble residue produced.

### EXAMPLE 8

### Release of nitric acid into water from pellets of N,N,N′,N′-Tetraallylpropane-1,3-dimethylammonium tosylate quaternary polymer

The same method was used as Example 5 but using following materials: N,N,N′,N′ tetrallylpropane-1,3-dimethylammonium tosylate (0.5 g) with Nitric acid (35 wt %, 0.3 g) and Irgacure 2022 (Ciba, 0.026 g).

Additionally, the same method was repeated but 60 wt % nitric acid was used instead of the 35 wt % acid.

Acid was released gradually in water (20° C.) with a lower pH reached more quickly when 60 wt % nitric acid was used. A similar pH was achieved from the acid containing pellets compared to a reference of the equivalent amount of nitric acid solution in water; the two values becoming more similar by increasing the duration of the pellets in water.

Only traces of the polymer had dissolved into water for both acid concentrations after 10 minutes.

1. A method of encapsulating a substance including the steps of:
providing a monomer which includes a group of sub-formula (I) 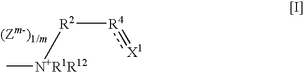
where R² and R³ are independently selected from (CR⁷R⁸)ₘ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, and
R⁴ and R⁵ are independently selected from CH or CR¹¹ where R¹¹ is an electron withdrawing group;
the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen, fluorine or other substituents;
R¹ is selected from hydrogen, halo, nitro, or hydrocarbyl, optionally substituted or interposed with functional groups;
R¹² is selected from hydrogen, halo, nitro, hydrocarbyl, optionally substituted or interposed with functional groups, or 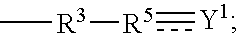
and
Z is an anion of charge m;
mixing the monomer with the substance and, optionally, at least one of a solvent for the monomer and an initiator to form a monomer containing mixture;
placing a pre-determined quantity of the monomer containing mixture in a pre-determined location so as to form a desired shape; and
polymerising the monomer so as to produce a polymeric matrix of a desired shape which encapsulates the substance.

2. A method according to claim 1 in which the pre-determined quantity of the monomer containing mixture is placed in a mould of a desired shape.

3. A method according to claim 1 in which one or more pre-determined quantities of the monomer containing mixture are deposited in a controlled and repeatable manner on one or more surfaces having controlled characteristics so that the quantities of the monomer containing mixtures form desired shapes, and the monomer in each deposited mixture is polymerised to produce at least one polymeric matrix of a desired shape each of which encapsulates the substance.

4. A method according to claim 1 in which the polymeric matrix is a capsule of dimensions greater than 1 mm.

5. A method according to claim 1 in which the substance is a liquid.

6. A method according to claim 5 in which the liquid acts a solvent for the monomer, and the mixing of the monomer with the liquid causes the liquid to dissolve the monomer.

7. A method according to claim 5 in which the liquid includes one or more solutes dissolved in a solvent.

8. A method according to claim 7 in which the substance is an acid.

9. A method according to claim 8 in which the acid is nitric acid.

10. A method according to claim 8 in which the acid is phosphoric acid or citric acid.

11. A method according to claim 1 in which the substance includes a polar liquid.

12. A method according to claim 1 in which the monomer and the substance are additionally mixed with a solvent for the monomer, and wherein the solvent for the monomer is a polar liquid.

13. A method according to claim 11 in which the polar liquid is water.

14. A method according to claim 1, in which the substance is a solid.

15. A method according to claim 14 in which the solid is an ionic solid.

16. A method according to claim 15 in which the ionic solid is sodium dithionate.

17. A method according to claim 1 in which the substance is a hazardous chemical, such as a biocide, an oxidising agent, a reducing agent, an acid, or an alkali.

18. A method according to claim 1 in which the monomer is polymerised by exposure to ultraviolet radiation.

19. A method according to claim 1 in which Z^{m-} is a halide ion, preferably Br⁻, tosylate, triflate, a borate ion, PF₆⁻, or a carboxylic acid ester.

20. A method according to claim 1 in which the monomer is a compound of structure (II) 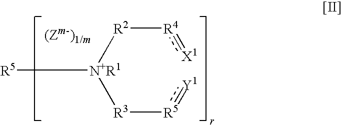
where X¹, Y¹, R², R³, R⁴, R⁵ and the dotted bonds are as defined in claim 1, r is an integer of 1 or more, and R⁶ is a bridging group, an optionally substituted hydrocarbyl group, a perhaloalkyl group, a siloxane group or an amide.

21. A method according to claim 20 in which the monomer is a compound of formula (III) 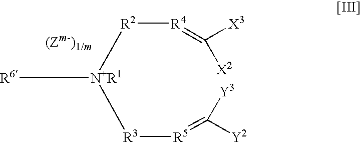
where X², X³, Y², Y³, R², R³, R⁴ and R⁵ are as defined in claim 1, R⁶′ is an optionally substituted hydrocarbyl group, a perhaloalkyl group, a siloxane group or an amide.

22. A method according to claim 20 in which R⁶ is an optionally substituted hydrocarbyl group having three or more carbon atoms.

23. A method according to claim 20 in which R⁶ is a straight or branched alkyl group, optionally substituted or interposed with functional groups.

24. A method according to claim 23 in which R⁶ has between one and twenty carbon atoms, preferably between two and twelve carbon atoms.

25. A method according to claim 20 in which R¹ and R⁶ together with the quaternarised N atom to which they are attached form a heterocyclic structure.

26. A method according to claim 25 in which R¹ and R⁶ together with the quaternarised N to which they are attached form an optionally substituted heterocyclic structure comprising a four to eight membered ring.

27. A method according to claim 26 in which the optionally substituted heterocyclic structure is a five membered ring.

28. A method according to claim 26 in which the optionally substituted heterocyclic structure is a six membered ring.

29. A method according to claim 28 in which R¹ and R⁶ or R⁶′ together with the quaternarised N to which they are attached form an optionally substituted piperidine ring.

30. A method according to claim 29 in which the monomer is compound of formula (IV)

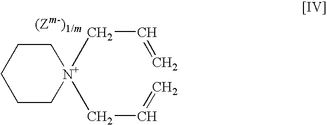

31. A method according to claim 26 in which the heterocyclic structure includes at least one additional heteroatom in addition to the quaternarised N to which R¹ and R⁶ are attached.

32. A method according to claim 31 in which the heterocyclic structure includes at least two N heteroatoms.

33. A method according to claim 32 in which the monomer is a compound of formula (V) 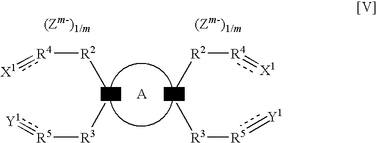
where A is a four to eight membered heterocyclic ring and the quaternarised nitrogens are present at any suitable pair of positions in the ring.

34. A method according to claim 33 in which A is a six membered ring.

35. A method according to claim 34 in which A is an optionally substituted piperazine ring.

36. A method according to claim 35 in which the monomer is a compound of formula (VI)

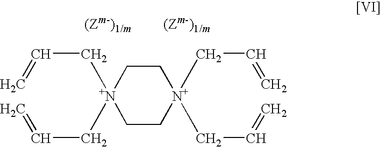

37. A method according to claim 24 in which the monomer is a compound of formula (VII) 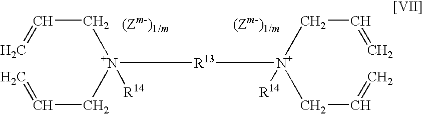
where R¹³ is a straight or branched alkyl group, preferably having between one and twenty carbon atoms, most preferably having between two and twelve carbon atoms;
R¹⁴ is hydrogen or a straight or branched alkyl group, preferably having between one and five carbon atoms, most preferably methyl or ethyl; and
Z^{m-} is as defined in relation to claim 1.

38. A method according to claim 37 in which the monomer is a compound of formula (VIII)

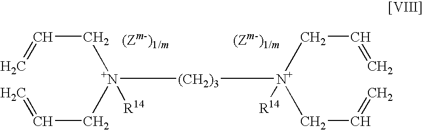

39. A method according to claim 38 in which the monomer is a compound of formula (IX)

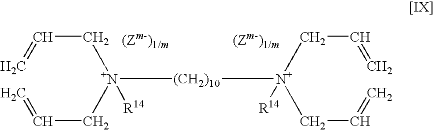

40. A method according to claim 37 in which R¹⁴ is methyl.

41. A method according to claim 1 in which the step of polymerising the monomer produces a homopolymer.

42. A method according to claim 1 in which the step of polymerising the monomer produces a copolymer, the monomer being mixed with different monomer units.

43. A method according to claim 42 in which the monomer is copolymerised with a cross-linker.

44. A method according to claim 42 in which the cross-linker is a compound of formula (VII) as defined in claim 37.

45. A method according to claim 44 in which the cross-linker is a compound of formula (VIII) as defined in claim 38.

46. A method according to claim 44 in which the cross-linker is a compound of formula (IX) as defined in claim 39.

47. A method according to claim 44 in which R¹⁴ is methyl.
